(19) United States
(12) Patent Application Publication
(10) Pub. No.: US 2019/0164296 A1
(43) Pub. Date: May 30, 2019

(54) SYSTEMS AND METHODS FOR DETERMINING A CONFIDENCE MEASURE FOR A MOTION VECTOR

(71) Applicant: QUALCOMM Incorporated, San Diego, CA (US)

(72) Inventors: Shyamprasad Chikkerur, San Diego, CA (US); Aravind Alagappan, San Diego, CA (US); Yunqing Chen, Los Altos, CA (US); Dangdang Shao, San Diego, CA (US)

(21) Appl. No.: 16/200,257

(22) Filed: Nov. 26, 2018

Related U.S. Application Data
(60) Provisional application No. 62/591,026, filed on Nov. 27, 2017.

(51) Int. Cl. G06T 7/223; G06K 9/62

(52) U.S. Cl. CPC G06T 7/223; G06K 9/6223

(57) ABSTRACT

A method is described. The method is performed by an electronic device. The method includes determining, in a loop, a plurality of motion vectors for an image. The method also includes determining a confidence measure for at least one of the plurality motion vectors in the loop with the motion vector determination.

### RELATED APPLICATION

This application is related to and claims priority to U.S. Provisional Patent Application Ser. No. 62/591,026, filed Nov. 27, 2017, for “SYSTEMS AND METHODS FOR DETERMINING A CONFIDENCE MEASURE.”

### FIELD OF DISCLOSURE

The present disclosure relates generally to electronic devices. More specifically, the present disclosure relates to systems and methods for determining a confidence measure for a motion vector.

### BACKGROUND

Some electronic devices (e.g., cameras, video camcorders, digital cameras, cellular phones, smart phones, computers, televisions, automobiles, personal cameras, action cameras, surveillance cameras, mounted cameras, connected cameras, robots, drones, smart applications, healthcare equipment, set-top boxes, etc.) capture and/or utilize images. For example, a smartphone may capture and/or process still and/or video images. Processing images may demand a relatively large amount of time, memory, and energy resources. The resources demanded may vary in accordance with the complexity of the processing.

In some cases, images may be processed inefficiently. For example, significant delays may be introduced and/or a large amount of resources may be consumed in image processing. As can be observed from this discussion, systems and methods that improve image processing may be beneficial.

### SUMMARY

A method performed by an electronic device is described. The method includes determining, in a loop, a plurality of motion vectors for an image. The method also includes determining a confidence measure for at least one of the plurality of motion vectors in the loop with the motion vector determination.

The confidence measure may be determined without global image statistics. Determining the confidence measure may include determining a neighbor activity measure for the at least one of the motion vectors. Determining the neighbor activity measure may include determining at least one measure of motion vector variance based on the at least one of the motion vectors and at least one neighboring motion vector.

Determining the confidence measure may include determining a clustering measure for the at least one of the motion vectors. Determining the clustering measure may include determining a distribution of one or more K-means clusters of candidate motion vectors. Determining the confidence measure may be based on a combination of a neighbor activity measure and the clustering measure. The confidence measure may be a numeric value of a non-binary range.

The method may include outputting a motion vector field with associated confidence measures corresponding to the image. The method may include tracking an object in the image based on the confidence measure. The method may include registering the image based on the confidence measure.

An electronic device is also described. The electronic device includes a processor. The processor is configured to determine, in a loop, a plurality of motion vectors for an image. The processor is also configured to determine a confidence measure for at least one of the motion vectors in-loop with the motion vector determination.

An apparatus is also described. The apparatus includes means for determining, in a loop, a plurality of motion vectors for an image. The apparatus also includes means for determining a confidence measure for at least one of the motion vectors in-loop with the motion vector determination.

A non-transitory tangible computer-readable medium storing computer executable code is also described. The computer-readable medium includes code for causing an electronic device to determine, in a loop, a plurality of motion vectors for an image. The computer-readable medium also includes code for causing the electronic device to determine a confidence measure for a motion vector in-loop with the motion vector determination.

### BRIEF DESCRIPTION OF THE DRAWINGS

FIG. 1 is a block diagram illustrating one example of an electronic device in which systems and methods for determining a confidence measure for a motion vector may be implemented;

FIG. 2 is a flow diagram illustrating one configuration of a method for determining a confidence measure for a motion vector;

FIG. 3 is a flow diagram illustrating another configuration of a method for determining a confidence measure for a motion vector;

FIG. 4 is a diagram illustrating an example of a set of blocks of pixels;

FIG. 5 is a flow diagram illustrating an example of a method for determining a neighbor activity measure;

FIG. 6 is a flow diagram illustrating an example of a method for determining a clustering measure;

FIG. 7 is a flow diagram illustrating an example of a method for mapping motion vectors to clusters;

FIG. 8 is a flow diagram illustrating an example of a method for determining a clustering measure based on clusters; and

FIG. 9 illustrates certain components that may be included within an electronic device configured to implement various configurations of the systems and methods disclosed herein.

### DETAILED DESCRIPTION

Estimating motion between images (e.g., video frames) often demands a relatively large amount of computational resources. Some approaches may provide motion estimation for all pixels in a video sequence. This may be difficult to achieve, particularly for high frame rate video. Due to computational costs and complexity, motion estimation may be performed for groups of pixels (e.g., blocks of pixels), rather than for every pixel in the video content in some approaches.

Motion estimation may also be challenging for other reasons. For example, motion estimation may be inaccurate when the image content includes occluded objects, noise, and/or flat regions. For instance, zoom-in and/or zoom-out motion along the borders of the video content may occlude a moving object, or a moving object in the middle of the video content may be occluded by a stationary object. Motion for flat regions may also be difficult to estimate, since flat regions have little or no texture.

Some approaches for motion estimation may attempt to improve motion estimation accuracy by using global image statistics and/or by performing motion estimation in multiple orders (e.g., forward and backward optical flow). For example, global image statistics may include motion vectors over an entire image (e.g., video frame). Using global frame statistics may add computational complexity and delay, since statistics (e.g., motion vectors) for an entire image are computed before the statistics may be used to improve estimation accuracy. Forward and backward motion estimation also add computational complexity.

Due to the aforementioned challenges, estimated motion may be computationally costly or may not be reliable. Unreliable motion estimation may degrade performance for applications that need reliable motion information. For example, automotive applications, medical applications, and surveillance applications may be highly sensitive to error.

Some configurations of the systems and methods disclosed herein may help to address some or all of the aforementioned challenges. For example, some configurations may determine a confidence measure for a motion vector. The confidence measure may indicate a degree of confidence or quality in the accuracy of a motion vector. Some configurations may determine the confidence measure in a loop with motion vector determination. For instance, the confidence measure may be determined within a computational loop for determining motion vectors. This may help to reduce computational complexity and/or delay by not relying on global image statistics. For example, a confidence measure may be determined for a motion vector without needing to wait for all of the motion vectors of an image (e.g., of all pixels or blocks of an image) to be determined. In some configurations, the confidence measure may be useful for a variety of image content (e.g., high-activity regions and/or flat regions). For example, the confidence measure may be based on a neighbor activity measure and a clustering measure, which may complement each other in high activity and flat regions.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

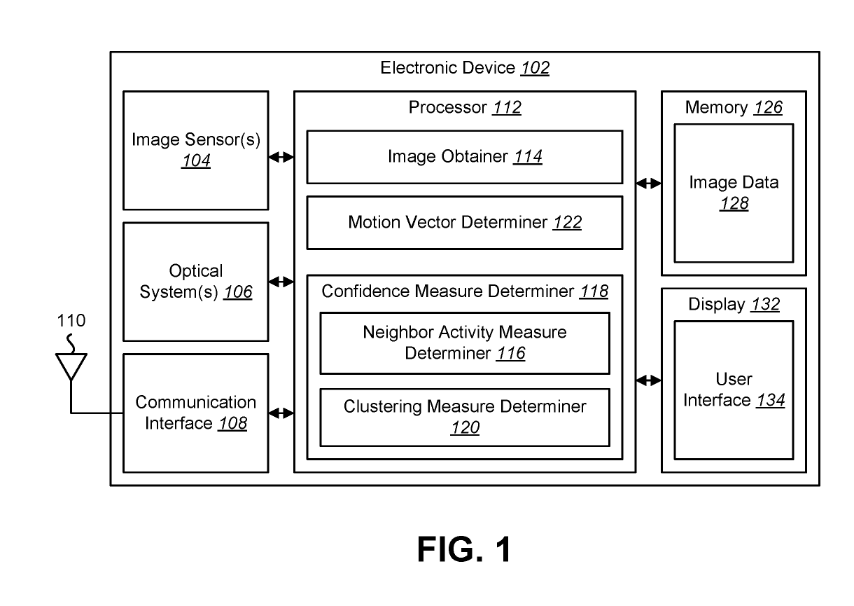

FIG. 1 is a block diagram illustrating one example of an electronic device 102 in which systems and methods for determining a confidence measure for a motion vector may be implemented. Examples of the electronic device 102 may include cellular phones, smart phones, computers (e.g., desktop computers, laptop computers, etc.), tablet devices, media players, cameras, video camcorders, digital cameras, televisions, automobiles, personal cameras, action cameras, surveillance cameras, mounted cameras, connected cameras, headsets (e.g., virtual reality (VR) headsets, augmented reality (AR) headsets, etc.), robots, aircraft, drones, unmanned aerial vehicles (UAVs), healthcare equipment, gaming consoles, personal digital assistants (PDAs), set-top boxes, etc. The electronic device 102 may include one or more components or elements. One or more of the components or elements may be implemented in hardware (e.g., circuitry), in a combination of hardware and software (e.g., a processor with instructions) and/or in a combination of hardware and firmware.

In some configurations, the electronic device 102 may include one or more processors 112, memory 126 (e.g., one or more memory devices), one or more displays 132, one or more image sensors 104, one or more optical systems 106, and/or one or more communication interfaces 108. The processor(s) 112 may be coupled to (e.g., in electronic communication with) the memory 126, display 132, image sensor(s) 104, optical system(s) 106, and/or communication interface 108. It should be noted that one or more of the elements illustrated in FIG. 1 may not be included in some configurations. For example, the electronic device 102 may or may not include an image sensor 104 and/or optical system(s) 106. Additionally or alternatively, the electronic device 102 may or may not include a display 132. Additionally or alternatively, the electronic device 102 may or may not include a communication interface 108.

The memory 126 may store instructions and/or data. The processor 112 may access (e.g., read from and/or write to) the memory 126. Examples of instructions and/or data that may be stored by the memory 126 may include image data 128 (e.g., pixels, video frames, video, still images, burst frames, etc.), image obtainer 114 instructions, motion vector determiner 122 instructions, confidence measure determiner 118 instructions, neighbor activity measure determiner 116 instructions, clustering measure determiner 120 instructions, and/or instructions for other elements, etc.

In some configurations, the electronic device 102 (e.g., the memory 126) may include an image data buffer (not shown). The image data buffer may buffer (e.g., store) image data. The buffered image data may be provided to the processor 112.

The communication interface 108 may enable the electronic device 102 to communicate with one or more other electronic devices. For example, the communication interface 108 may provide an interface for wired and/or wireless communications. In some configurations, the communication interface 108 may be coupled to one or more antennas 110 for transmitting and/or receiving radio frequency (RF) signals. For example, the communication interface 108 may enable one or more kinds of wireless (e.g., cellular, wireless local area network (WLAN), wireless personal area network (WPAN), etc.) communication. Additionally or alternatively, the communication interface 108 may enable one or more kinds of cable and/or wireline (e.g., Universal Serial Bus (USB), Ethernet, High Definition Multimedia Interface (HDMI), fiber optic cable, etc.) communication.

In some configurations, multiple communication interfaces 108 may be implemented and/or utilized. For example, one communication interface 108 may be a cellular (e.g., 3G, Long Term Evolution (LTE), CDMA, etc.) communication interface 108, another communication interface 108 may be an Ethernet interface, another communication interface 108 may be a universal serial bus (USB) interface, and yet another communication interface 108 may be a wireless local area network (WLAN) interface (e.g., Institute of Electrical and Electronics Engineers (IEEE) 802.11 interface).

The electronic device 102 (e.g., image obtainer 114) may obtain (e.g., receive) one or more images (e.g., digital images, image frames, frames, video, etc.). The one or more images may be images of a scene (e.g., one or more objects and/or background). For example, the electronic device 102 may include one or more image sensors 104 and one or more optical systems 106 (e.g., lenses). An optical system 106 may focus images of objects that are located within the field of view of the optical system 106 onto an image sensor 104. The optical system(s) 106 may be coupled to and/or controlled by the processor 112 in some configurations.

A camera may include at least one image sensor and at least one optical system. Accordingly, the electronic device 102 may be one or more cameras and/or may include one or more cameras in some implementations. In some configurations, the image sensor(s) 104 may capture (e.g., receive) the one or more images (e.g., image frames, video, still images, burst mode images, etc.). In some implementations, the electronic device 102 may include multiple optical system(s) 106 and/or multiple image sensors 104. Different lenses may each be paired with separate image sensors 104 in some configurations. Additionally or alternatively, two or more lenses may share the same image sensor 104.

In some configurations, the electronic device 102 may request and/or receive the one or more images from another device (e.g., one or more external image sensors coupled to the electronic device 102, surround-view camera, 360-degree camera, VR camera, drone camera, a network server, traffic camera, drop camera, automobile camera, web camera, smartphone camera, etc.). In some configurations, the electronic device 102 may request and/or receive the one or more images via the communication interface 108. For example, the electronic device 102 may or may not include a camera (e.g., an image sensor 104 and/or optical system 106) and may receive images from one or more remote devices.

The electronic device may include one or more displays 132. The display(s) 132 may present one or more images (e.g., video, still images, graphics, three-dimensional (3D) image content, symbols, characters, etc.). The display(s) 132 may be implemented with one or more display technologies (e.g., liquid crystal display (LCD), organic light-emitting diode (OLED), plasma, cathode ray tube (CRT), etc.). The display(s) 132 may be integrated into the electronic device 102 or may be coupled to the electronic device 102. In some configurations, the content described herein (e.g., image content, video, etc.) may be presented on the display(s) 132. In some configurations, all or portions of the images that are being captured by the image sensor(s) 104 may be presented on the display 132.

In some configurations, the electronic device 102 may present a user interface 134 on the display 132. For example, the user interface 134 may enable a user to interact with the electronic device 102. In some configurations, the display 132 may be a touchscreen that receives input from physical touch (by a finger, stylus, or other tool, for example). Additionally or alternatively, the electronic device 102 may include or be coupled to another input interface. For example, the electronic device 102 may include a camera and may detect user gestures (e.g., hand gestures, arm gestures, eye tracking, eyelid blink, etc.). In another example, the electronic device 102 may be linked to a mouse and may detect a mouse click. In yet another example, the electronic device 102 may be linked to one or more other controllers (e.g., game controllers, joy sticks, touch pads, motion sensors, etc.) and may detect input from the one or more controllers.

The processor 112 may include and/or implement an image obtainer 114, a motion vector determiner 122, and/or a confidence measure determiner 118. In some configurations, the confidence measure determiner 118 may include a neighbor activity measure determiner 116 and/or a clustering measure determiner 120. It should be noted that not all of the elements illustrated in the electronic device 102 and/or processor 112 may be required in some configurations. Additionally or alternatively, one or more of the elements illustrated in the processor 112 may be implemented separately from the processor 112 (e.g., in other circuitry, on another processor, and/or on a separate electronic device, etc.).

The processor 112 may include and/or implement an image obtainer 114. One or more images (e.g., video frames, burst shots, etc.) may be provided to the image obtainer 114. For example, the image obtainer 114 may obtain (e.g., receive) images from one or more image sensors 104. For instance, the image obtainer 114 may receive image data from one or more image sensors 104 and/or from one or more remote cameras. As described above, the image(s) may be captured from the image sensor(s) 104 included in the electronic device 102 and/or may be captured from one or more remote camera(s). In some configurations, the image obtainer 114 may obtain multiple images (e.g., a sequence of video frames).

In some configurations, the image obtainer 114 may request and/or receive one or more images (e.g., video frames, etc.). For example, the image obtainer 114 may request and/or receive one or more images from a remote device (e.g., external camera(s), remote server, remote electronic device, etc.) via the communication interface 108. Additionally or alternatively, the image obtainer 114 may obtain one or more previously stored images from memory 126.

In some cases, the images may depict moving content (e.g., a moving scene, one or more moving objects, etc.). Moving content may occur due to movement of one or more objects (relative to a scene or background, for example) and/or due to movement of the image sensor(s) that capture image content. For instance, a moving object may be changing position through a series of images (e.g., video frames, etc.).

The processor 112 may include and/or implement a motion vector determiner 122. A motion vector may be a vector that indicates motion between images. For example, a motion vector may correspond to a pixel or block of pixels (e.g., object) in an image and may indicate movement of the pixel or block of pixels (e.g., object) from the image to another image (e.g., previous image, concurrent image, subsequent image). A motion vector may indicate direction and magnitude of movement of the pixel or block of pixels between images. The origin of the motion vector may be the pixel or block of pixels (e.g., block center) in the image and the endpoint of the motion vector may be the location of the pixel or block of pixels (e.g., block center) in the other image.

The motion vector determiner 122 may determine one or more motion vectors based on images (e.g., two or more video frames, burst frames, still images, etc.). For example, the motion vector determiner 122 may search a portion of another image for a corresponding portion of a current image. For instance, the motion vector determiner 122 may compare a portion of an image (e.g., one or more blocks of pixels of an image) to a portion of another image (e.g., one or more blocks of pixels of a subsequent image) to determine a motion vector.

In some approaches, the motion vector determiner 122 may loop (e.g., iterate) through portions of an image, determining a motion vector for each of the portions. For example, the motion vector determiner 122 may progressively determine a motion vector for each of a set of blocks of pixels (e.g., 4×4, 8×8, 16×16 blocks of pixels, etc.) of an image. In some configurations, the motion vector determiner 122 may loop through the image row-by-row. For example, the loop may proceed from left to right (or right to left) and from top to bottom (or bottom to top) for each pixel or pixel block. In some approaches, the motion vector determiner 122 may determine a motion vector for each pixel in the image in a loop. In some approaches, the electronic device 102 (e.g., motion vector determiner 122) may buffer a group of motion vectors (e.g., one or more rows of motion vectors). The motion vectors may be buffered in the memory 126.

The processor 112 may include and/or implement a confidence measure determiner 118. The confidence measure determiner 118 may determine a confidence measure for one or more motion vectors (e.g., for each motion vector). The confidence measure may indicate a degree of confidence (e.g., reliability) of motion vector accuracy. In some configurations, the confidence measure may be expressed within a numeric range (e.g., a non-binary range from 0-15) for each motion vector. For example, the confidence measure may be a non-binary indication of confidence. An example of the non-binary indication is a non-binary range, which may be a range of values that includes more than two values for indicating a range.

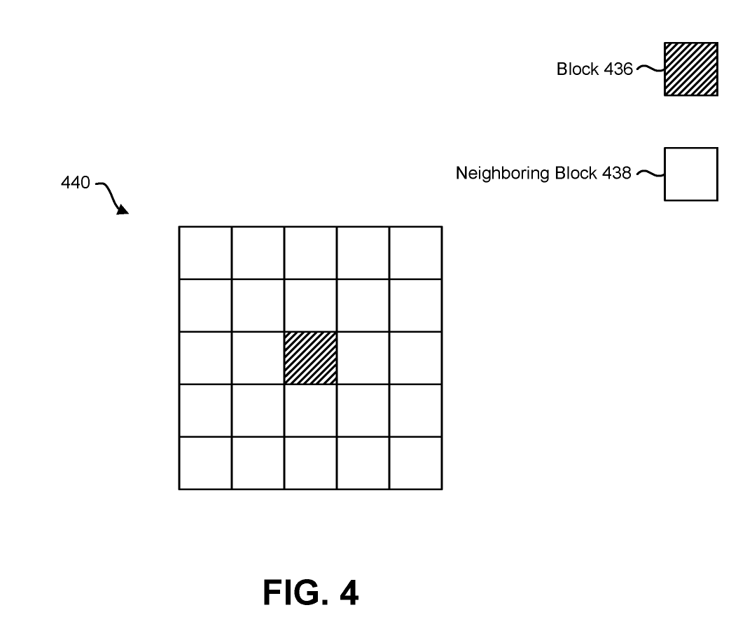

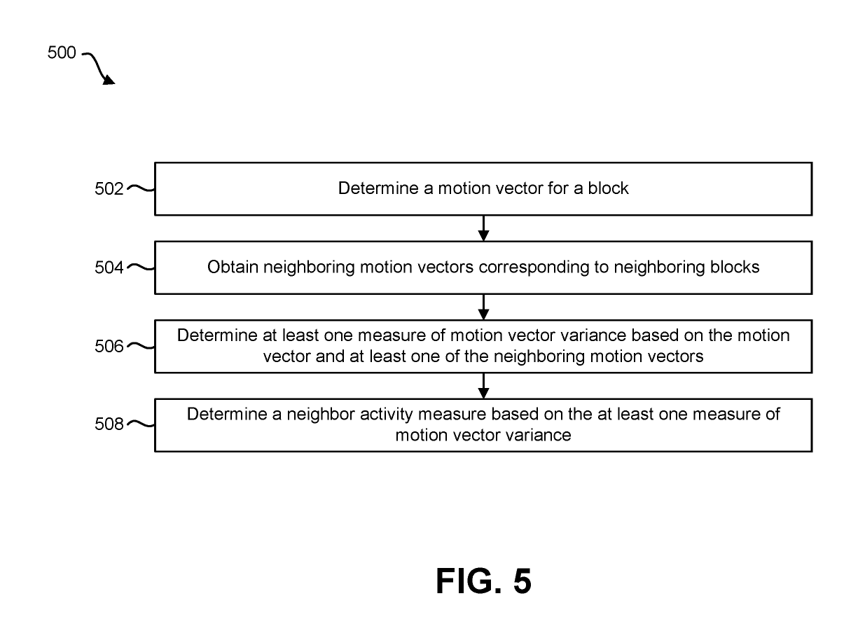

In some configurations, the confidence measure determiner 118 may determine a confidence measure for a motion vector in-loop with motion vector determination. As used herein, the term “in-loop” or “in the loop” may mean that the confidence measure is determined for each motion vector in a computational loop (e.g., the same computational loop) as the motion vector determination. For example, the confidence measure may be determined without using global image statistics (or “whole frame” statistics). Additionally or alternatively, the confidence measure determination for one or more blocks may be performed before motion vectors are determined for all blocks in the frame. In some configurations, the confidence measure determiner 118 may determine a confidence measure for a block in the same loop with the motion vector determination of a neighboring block. For example, in a loop (e.g., iteration) where a last motion vector in a set of blocks (e.g., an 8×8 set of neighboring blocks) is determined, the confidence measure for a block (e.g., central block) in the set of neighboring blocks may be determined. Accordingly, confidence measure determination for a block may lag motion vector determination for the block by a number of blocks (e.g., a number of loop iterations). Additional detail regarding the lag is given in connection with FIGS. 4-5. In some examples, one “loop” may persist over a single image or a single frame.

Some other approaches rely on determining all motion vectors for a frame before determining whether each motion vector is reliable (based on global frame statistics). Some approaches may also determine motion vectors in forward and reverse orders (e.g., from a first frame to a second frame and from the second frame to the first frame) in order to determine whether motion vectors are reliable.

In some configurations, the confidence measure determiner 118 may determine a confidence measure for one or more motion vectors without having first determined all motion vectors for an image (e.g., frame) and/or without having determined one or more motion vectors in multiple frame orders (e.g., forward and reverse orders). For example, confidence measure computation may not expect or utilize global image statistics and/or statistics from another image (e.g., previous image or subsequent image) to improve precision. Some configurations may utilize limited neighbor information (e.g., information of a set of neighboring pixels and/or a set of neighboring pixels, etc.) in the confidence measure computation. For example, the confidence measure may be determined in-loop based on a buffered set of motion vectors. For instance, a number of loop iterations may be performed to determine and buffer a set of motion vectors. Once enough motion vectors have been buffered (e.g., enough motion vectors to provide a set of neighboring motion vectors corresponding to neighboring pixels or blocks of pixels), the confidence measure determination may begin to be performed in the loop (e.g., a loop iteration) based on the buffered set of motion vectors in some configurations. Accordingly, the pixel or block of pixels for which a motion vector is being determined may be different from the pixel of block of pixels for which the confidence measure is being determined in a loop iteration in some approaches. Accordingly, some configurations of the systems and methods disclosed herein may improve efficiency and/or reduce delay in motion vector reliability determination.

In some configurations, the confidence measure determiner 118 may determine the confidence measure for a motion vector based on a neighbor activity measure and/or based on a clustering measure. For example, the confidence measure determiner 118 may include a neighbor activity measure determiner 116 and/or a clustering measure determiner 120.

The neighbor activity measure determiner 116 may determine a neighbor activity measure. The neighbor activity measure may indicate a degree of variance based on one or more neighboring pixels or blocks of pixels. For example, determining the neighbor activity measure may include determining a measure of variance of the motion vector of a block of pixels relative to motion vectors of neighboring pixels or blocks of pixels to produce the neighbor activity measure. In some configurations, a neighbor activity measure may be determined based on a buffered set of motion vectors for a subset of the image. For example, the neighbor activity measure determination for a block may lag the motion vector determination for the block by a number of blocks and/or rows.

In some configurations, the neighbor activity measure determiner 116 may determine the neighbor activity measure as a variance of a motion vector of a block (e.g., central block) as follows. A set of blocks (e.g., a neighbor map) may be utilized to compute motion vector variance in a first direction (e.g., Var_{MV}_{_{X}}), and motion vector variance in a second direction (e.g., Var_{MV}_{_{Y}}). For example, the motion vector variance in a first direction (e.g., Var_{MV}_{_{X}}) may be the variance of first components (e.g., the x components) of the motion vectors corresponding to a set of blocks. The motion vector variance in a second direction (e.g., Var_{MV}_{_{Y}}) may be the variance of second components (e.g., the y components) of the motion vectors corresponding to the set of blocks. In some approaches, since the block may move in two-dimensional (2D) space, X may represent a horizontal direction and Y may represent a vertical direction.

The motion vector variances may be combined to determine the neighbor activity measure. The neighbor activity measure may provide an indication of the confidence or reliability of the motion vector of the block (e.g., central block). In some configurations, the neighbor activity measure may be determined in accordance with Equation (1).

Confidence_{MV}_{_{Activity}}=CLIP(0,15,(SQRT(Var_{MV}_{_{X}}+Var_{MV}_{_{Y}})*λ_{MV})) (1)

In Equation (1), Confidence_{MV}_{_{Activity}} is the neighbor activity measure, CLIP( ) denotes a clip function, SQRT( ) denotes a square root function, Var_{MV}_{_{X}} is a motion vector variance in a horizontal direction, Var_{MV}_{_{Y}} is a motion vector variance in a vertical direction, and λ_{MV} is a scale factor. For instance, λ_{MV} may be a scale factor to accommodate a higher range. Examples of λ_{MV} may include a value of 1, a value within a range of λ_{MV}>0 and λ_{MV}<2, or another value. It should be noted that although a clipping range of 0-15 is given as an example, other ranges may be used. The neighbor activity measure may be utilized to determine the confidence measure corresponding to the motion vector of the block (e.g., central block), for example. Additional examples of determining the neighbor activity measure are given in connection with FIGS. 4-5.

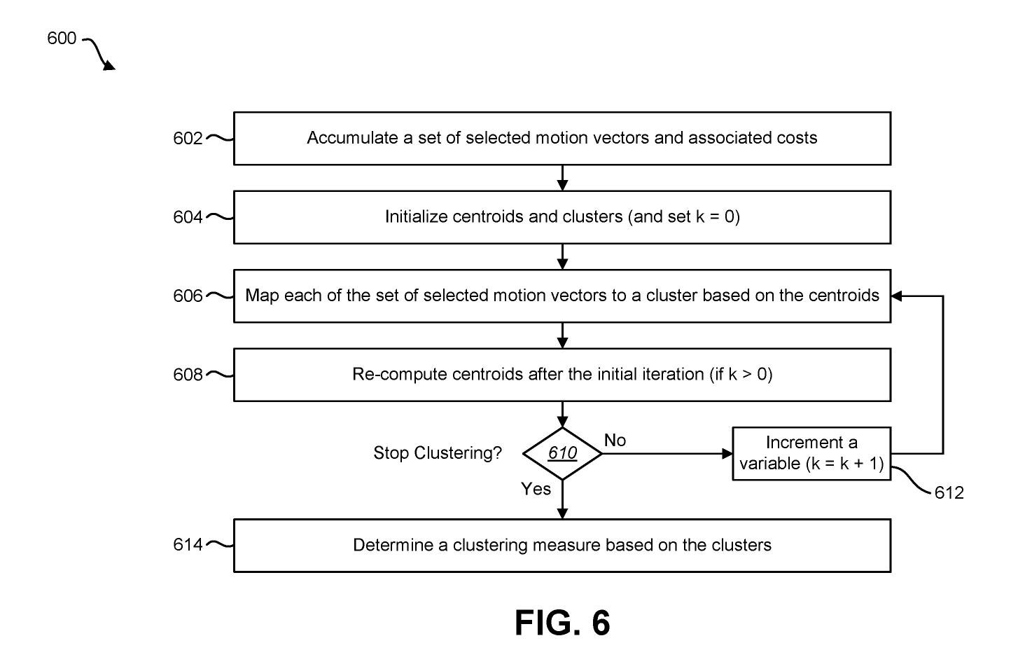

The clustering measure determiner 120 may determine a clustering measure. The clustering measure may indicate a degree of motion vector clustering, which may express how closely distributed the motion vectors occur. In some examples, the clustering measure is a value of a set of values, where each of the set of values indicates a differing degree of clustering. For example, if a spread between clusters is less than a threshold, a first clustering measure may be determined that indicates a close distribution between the clusters. Additionally or alternatively, clustering measures may be assigned based on cluster frequency as compared to one or more thresholds. A cluster frequency may be a number of motion vectors within the cluster or a proportion (e.g., percentage) of motion vectors within the cluster. In some configurations, determining the clustering measure may include determining a distribution of one or more K-means clusters of motion vectors. K-means clustering is an approach that may be utilized to group the motion vectors into K clusters, where each motion vector may be grouped into a cluster with a nearest mean. More detailed examples of determining the clustering measure are given in connection with FIGS. 6-8.

In some configurations, the confidence measure determiner 118 may determine the clustering measure based on a combination of independent measures for a motion vector. Independent measures for a motion vector may be measures of motion vector characteristics that may be determined independently of each other. Examples of the independent measures may include the neighbor activity measure and the clustering measure. In some configurations, the confidence measure determiner 118 may combine the neighbor activity measure and the clustering measure to produce the confidence measure. In some approaches, the confidence measure (e.g., overall confidence measure) may be determined in accordance with Equation (2).

C_{MV}=CLIP(0,15,(λ₁*Confidence_{MV}_{_{Activity}}+λ₂*Confidence_{MV}_{_{Cluster}})) (2)

In Equation (2), C_{MV} is the confidence measure for a motion vector, CLIP( ) denotes a clip function, Confidence_{MV}_{_{Activity}} is the neighbor activity measure, λ₁ is a weighting value for the neighbor activity measure, Confidence_{MV}_{_{Cluster}} is the clustering measure, and λ₂ is a weighting value for the clustering measure. In some approaches, the weighting values may be heuristically tuned and/or used. Examples of the weighting values include λ₁=0.6 and λ₂=0.4 (a 60% to 40% split), though other values may be used. In Equation (2), 0 and 15 denote a range of the confidence measure, from most reliable to least reliable. For example, a motion vector with a confidence measure of 0 may indicate that the motion vector is very reliable, while a motion vector with a confidence measure of 15 may indicate a very unreliable motion vector. Other ranges may be utilized. In some examples, the confidence measure may help to provide a measure of reliability of an optical flow motion vector predicted in-loop with limited neighbor information.

In some configurations, the electronic device 102 may perform one or more operations based on the confidence measure. For example, the electronic device 102 may determine whether or not to utilize one or more motion vectors based on one or more corresponding confidence measures. In some configurations, the electronic device 102 may apply a threshold to a confidence measure to determine whether to use the corresponding motion vector (e.g., predicted motion vector). Utilizing the confidence measures to select (e.g., filter) motion vectors may increase overall motion vector quality, which may improve one or more operations based on the motion vector(s).

Some examples of operations that the electronic device 102 may perform based on the motion vectors and/or confidence measures may include frame rate conversion, frame rate upconversion (FRU), object tracking, object detection, and/or image registration, etc. For instance, the electronic device 102 may track an object in an image over a series of images based on the confidence measure(s), where the confidence measure(s) may indicate the reliability of the associated motion vector(s) for the object. Additionally or alternatively, the electronic device 102 may register (e.g., align) two images based on the confidence measure(s), where the confidence measure(s) may indicate whether one or more motion vector(s) should be utilized to register the images.

In more specific examples, the electronic device 102 may utilize the confidence measure for automotive applications (e.g., object detection, object tracking, navigation, collision avoidance, etc.), medical applications (e.g., image registration in medical imaging, magnetic resonance imaging (MRI), computed tomography (CT) scans, etc.), stereoscopic camera disparity determination and/or calibration, stereoscopic camera depth detection, photograph enhancement, etc. For example, the electronic device 102 may utilize the confidence measures to filter motion vectors that are input into one or more of the aforementioned operations and/or applications. In some approaches, an example of motion vector determination may include optical flow. Accordingly, some configurations of the systems and methods disclosed herein may be implemented in conjunction with optical flow and/or may improve upon optical flow.

In some configurations, the processor 112 may produce and/or output a motion vector field with corresponding confidence measures. For example, the processor 112 may produce a set of motion vectors, where each motion vector corresponds to a block of an image (e.g., frame). Each motion vector may have an associated confidence measure, indicating a degree of confidence of motion vector accuracy. The motion vector field and confidence measures may be utilized for one or more of the foregoing functions, operations, and/or applications.

The systems and methods disclosed herein may offer one or more benefits and/or advantages. For example, confidence measures may be produced with one or more processing region restrictions (e.g., within a search window region) and/or processing order restrictions (e.g., optical flow may be performed within a video pipe following raster order row by row for an image with one local compute unit (LCU) at a time). The confidence measures may be estimated in a single pass (e.g., only one direction (backward or forward) of motion may be estimated). This may be beneficial when there is no feedback mechanism to use each direction to improve accuracy. The confidence measures may be estimated without whole frame statistics. This may be helpful, since some hardware pipe optical flow approaches may not have whole frame statistics ahead of time to regularize cost functions or to get a global motion cue. Some approaches disclosed herein may help reduce hardware complexity, since multiple passes of an image may not be required. Some configurations may provide a confidence measure that captures motion vector precision for both high activity and flat regions. The confidence measure may be highly correlative with end point error (EPE) of a predicted motion vector with the ground truth motion vector.

Further benefits and/or advantages of some approaches are described as follows. Some configurations may be amenable to hardware implementation. For example, only a limited window (e.g., 5×5 window) of motion vector statistics may be utilized to determine the neighbor activity measure. The clustering measure may only need a set of best motion vectors of a current block and associated costs. Only 1 byte of statistics overhead may be generated for a local compute unit (LCU) size of 16×16 (with four 8×8 block motion vectors). The two measures may complement each other in high activity and flat regions. The confidence measure may align with regions of EPE (end point error) scores, where EPE scores refer to average error between |ground truth−predicted motion|, where ground truth is the actual optical flow for a given sequence.

Instead of a providing a binary good/bad score, the confidence measure may rate the motion on a scale based on motion vector accuracy. Some disadvantages of binary scoring as described as follows. A binary scoring approach may be sensitive to a threshold used to detect confidence. The same threshold may not perform equally well across low/high texture content. For example, a threshold that performs well for certain sequences may not perform well for other sequences. A binary metric may provide no indication of degradation severity. In comparison, some configurations of the confidence measure disclosed herein may provide an indication of degradation severity and/or may perform well over low and high texture content.

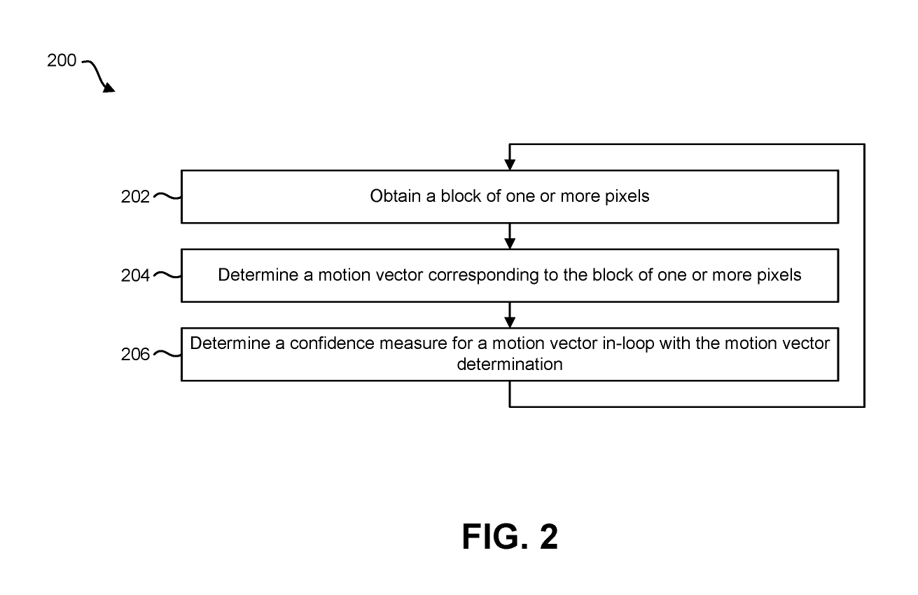

It should be noted that one or more of the elements or components of the electronic device 102 may be combined and/or divided. For example, one or more of the image obtainer 114, the motion vector determiner 122, the confidence measure determiner 118, the neighbor activity measure determiner 116, and/or the clustering measure determiner 120 may be combined. Additionally or alternatively, one or more of the image obtainer 114, the motion vector determiner 122, the confidence measure determiner 118, the neighbor activity measure determiner 116, and/or the clustering measure determiner 120 may be divided into elements or components that perform a subset of the operations thereof. In some configurations, the electronic device 102 may perform one or more of the functions, operations, methods, steps, etc., described in one or more of FIGS. 2-9.

FIG. 2 is a flow diagram illustrating one configuration of a method 200 for determining a confidence measure for a motion vector. The method 200 may be performed by the electronic device 102 described in connection with FIG. 1, for example. In some configurations, the electronic device 102 may obtain 202 a block of one or more pixels. This may be accomplished as described in connection with FIG. 1. For example, the electronic device 102 may obtain (e.g., read from memory, capture, and/or receive from another device, etc.) a subset of pixels of an image. For instance, the electronic device 102 may obtain an 8×8 block of pixels of an image. The electronic device 102 may also obtain another image or block of pixels of another image. For example, the electronic device 102 may receive two images or two image subsets and/or may retrieve two images or two image subsets from memory 126.

The electronic device 102 may determine 204 a motion vector corresponding to the block of one or more pixels. This may be accomplished as described in connection with FIG. 1. For example, the electronic device 102 may compare a portion of an image to one or more portions of another image (e.g., a subsequent frame) to determine a motion vector. In some approaches, determining 204 a motion vector may include comparing a block of an image with portions of another image within a search window. For example, the electronic device 102 may calculate a similarity metric (e.g., cross-correlation, sum of absolute differences (SAD), etc.) between a block of an image within a search window of another image (e.g., over 25 blocks of 8×8 pixels or over a 5×5 block neighborhood of another image). One or more similarity metrics (e.g., highest cross-correlation and/or lowest SAD) may indicate the motion vector (e.g., motion vector endpoint).

The electronic device 102 may determine 206 a confidence measure for a motion vector in-loop with the motion vector determination. This may be accomplished as described in connection with FIG. 1. For example, the electronic device 102 may determine a confidence measure for a motion vector corresponding to a block of pixels for at least some of the blocks of pixels in an image before all motion vectors are determined for all blocks of pixels in the image. This may avoid iterating over a frame multiple times (e.g., determining all motion vectors for a frame and then iterating over the motion vectors to determine reliability based on global frame statistics).

In some configurations, determining 206 the confidence measure may include determining a neighbor activity measure for the motion vector and/or determining a clustering measure for the motion vector. In some approaches, the confidence measure determination 206 may lag the motion vector determination 204 for a block of pixels. For example, a set of motion vectors corresponding to a subset of the image may be determined and buffered in hardware (e.g., memory) before the confidence measure is determined 206. As illustrated in FIG. 2, one or more steps of the method 200 may be repeated. For example, the method 200 may be performed in one loop for all of the pixel blocks in an image frame. For instance, the loop may finish when motion vectors with corresponding confidence measures are determined for the pixel blocks in the image. As described herein, the confidence measure determination 206 may be performed in-loop for at least one or more motion vectors, before a motion vector determination loop of an entire image (e.g., frame) is completed in some configurations. This may differ from approaches where a first loop is utilized to first determine all of the motion vectors for an image, and then a second loop is utilized to determine confidence measures for all of the motion vectors. For instance, motion vector determination and confidence measure determination for one image may be integrated into a single loop, where some (but not all) motion vectors in an image are determined and buffered to begin determining confidence measures in the loop before all motion vector determinations are complete for the image.

In an example, for simplicity, assume that a 3×3 set of pixel blocks (e.g., a corresponding 3×3 set of motion vectors) may be utilized to determine 206 a confidence measure corresponding to a central pixel block. Also assume that an image includes 10 rows (indexed 0-9) and 10 columns (indexed 0-9) of pixel blocks, where each pixel block may be expressed as (row, column). In order to determine 206 a confidence measure for a pixel block at (1, 1), the following procedure may be performed. Steps 202 and 204 are performed in the loop, row-by-row for pixel blocks from (0, 0) to (2, 2) (i.e., for two whole rows of pixel blocks, and then to the third column of the third row). This may produce motion vectors corresponding to each pixel block for indices from (0, 0) to (2, 2). Once the motion vectors are determined 204 up to (2, 2), the electronic device 102 may determine 206 the confidence measure in the loop for the motion vector at (1, 1). For example, the electronic device 102 may utilize motion vectors corresponding to neighboring pixel blocks at (0, 0), (0, 1), (0, 2), (1, 0), (1, 2), (2, 0), (2, 1), and (2, 2) to determine 206 the confidence measure for the pixel block at (1, 1). While the confidence measure determination 206 at (1, 1) lags the motion vector determination 204 up to (2, 2), the confidence measure determination 206 is performed in the loop with the motion vector determination 204, before all of the motion vectors for the whole image are determined (e.g., before the loop for motion vector determination 204 ends for the image). In continuing with the example, once the motion vector for (2, 3) is determined 204, the confidence measure for the pixel block at (1, 2) may be determined 206, and so on.

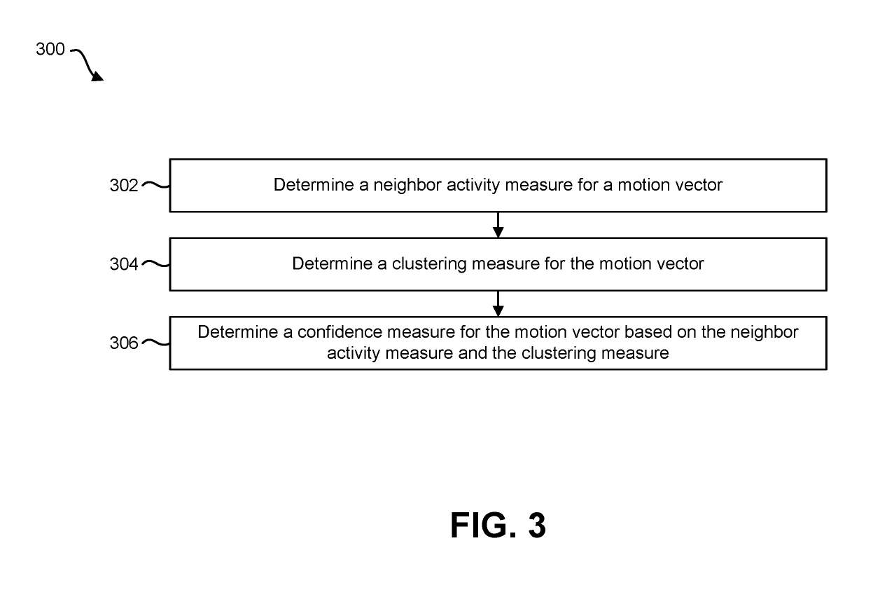

FIG. 3 is a flow diagram illustrating another configuration of a method 300 for determining a confidence measure for a motion vector. The method 300 may be performed by the electronic device 102 described in connection with FIG. 1, for example. In some configurations, the electronic device 102 may determine 302 a neighbor activity measure for a motion vector. This may be accomplished as described in connection with one or more of FIGS. 1-2 and/or 4-5. For example, the electronic device 102 may determine a variance of a motion vector of a block of pixels relative to motion vector(s) of one or more neighboring blocks as the neighbor activity measure. In some approaches, the neighbor activity measure may indicate the variance of a motion vector of an 8×8 block of pixels relative to motion vectors of neighboring blocks. The neighbor activity measure may provide an indication of relative confidence. For a motion vector, for example, a small amount of motion vector variation relative to neighboring motions vectors may indicate that a motion vector for a block is accurate.

The electronic device 102 may determine 304 a clustering measure for the motion vector. This may be accomplished as described in connection with one or more of FIGS. 1-2 and/or 6-8. For example, the electronic device 102 may cluster (e.g., group and/or associate) candidate motion vectors. The clustering may provide an indication of a distribution of candidate motion vectors. The clustering measure may be an indication of motion vector confidence based on the clustering. For example, motion vector confidence may be determined based on the distribution of candidate motion vectors. In some approaches, the clustering measure may be determined 304 in addition to the neighbor activity measure, since the neighbor activity measure may not provide a reliable measure of confidence for flat regions, for example. In some configurations, determining 304 the clustering measure may include performing K-means clustering of candidate motion vectors.

It should be noted that clustering may not be performed in some configurations and/or cases. For example, if a threshold number or proportion of motion vectors (e.g., >50% or other proportion of candidates) from a set of selected motion vectors are similar and/or have similar costs (e.g., have less than a threshold difference, distance, and/or amount of variance in the group of motion vectors and/or costs), the clustering measure may be directly set to a particular (e.g., predetermined) value and clustering may not be initiated. If a threshold number of motion vectors are not the same with the same cost, clustering may be performed and the clustering measure may be determined based on the clustering. The threshold may be heuristically tuned and/or used.

The electronic device 102 may determine 306 a confidence measure for the motion vector based on the neighbor activity measure and the clustering measure. This may be accomplished as described in connection with one or more of FIGS. 1-2 and/or Equation (2). For example, the neighbor activity measure and the clustering measure may be weighted together to assign a final motion vector confidence measure for a given block motion vector. It should be noted that the neighbor activity measure may not be well suited to measure confidence for flat regions in some cases. The clustering measure may complement the neighbor activity measure for flat regions. A clustering approach may be used to evaluate candidate motion vector region spread, which may help to deduce the motion confidence. For example, a clustering approach may be used if a majority of the motion vector candidates are focused in the same region.

FIG. 4 is a diagram illustrating an example of a set of blocks 440 of pixels. In particular, FIG. 4 illustrates an example of a block 436 of pixels and neighboring blocks 438 of pixels. The block 436 and the neighboring blocks 438 may be a portion of an image. In some examples, the block 436 and neighboring blocks 438 may each include a number of pixels (e.g., 4×4, 8×8, 16×16, etc.). In FIG. 4, the set of blocks 440 is a 5×5 set of blocks, where the block 436 and neighboring blocks 438 each include a number of pixels (e.g., 8×8 pixels). The set of blocks 440 may be referred to as a neighbor map. In the set of blocks 440, each block 436, 438 may have a corresponding motion vector determined for that location in the image, where the location is the block of pixels (e.g., a block of pixels described in connection with step 202 of FIG. 2). For example, the set of blocks 440 may be a neighbor map of motion vectors (e.g., a result space of motion vectors) for a group of pixels. In some approaches, when searching for motion vectors, the locations of the set of blocks 440 may correspond to a search space for motion vector determination in another image (as described in connection with step 204 of FIG. 2, for example).

The block 436 and the neighboring blocks 438 may be utilized (by the electronic device 102, for instance) to determine a neighbor activity measure. For example, some configurations of the systems and methods disclosed herein may determine the variance of a motion vector of the block 436 (e.g., a current 8×8 block) relative to the motion vectors of the neighboring blocks 438 to produce the neighbor activity measure. A premise of the neighbor activity measure may be that a motion vector may be considered to be determined accurately (e.g., optical flow has accurately predicted the motion vector) in a case that motion vectors from neighboring blocks are similar (e.g., variation between neighboring motion vectors may be small).

In some examples, the variance of the motion vector of the block 436 relative to the motion vectors of the neighboring blocks 438 may denote a statistical measure of variance of the motion vectors of the set of blocks 440. For instance, the electronic device 102 may use the horizontal components of all of the motions vectors corresponding to the set of blocks 440 to compute a first variance (e.g., population variance) and may use the vertical components of all of the motion vectors corresponding to the set of blocks 440 to compute a second variance (e.g., population variance). For instance, a variance may be computed by determining a mean of a population, summing squared differences between each sample in the population and the mean, and dividing by the number of samples. The first variance and the second variance may be combined (e.g., summed) in a function to express a magnitude of the variance. This variance may be relative to the motion vector because the set of motion vectors includes the motion vector and/or because the set of motion vectors for the variance calculation is determined based on the pixel location of the motion vector.

In some approaches, the set of blocks 440 (e.g., a 5×5 neighbor map) may be utilized (by the electronic device 102, for example) to compute motion vector variance in a first direction (e.g., Var_{MV}_{_{X}}), and motion vector variance in a second direction (e.g., Var_{MV}_{_{Y}}. For example, the motion vector variance in a first direction (e.g., Var_{MV}_{_{X}} ) may be the variance of first components (e.g., the x components, horizontal components, or pixel differences in a horizontal direction) of the motion vectors corresponding to the set of blocks 440. The motion vector variance in a second direction (e.g., Var_{MV}_{_{Y}}) may be the variance of second components (e.g., the y components or vertical components, or pixel differences in a vertical direction) of the motion vectors corresponding to the set of blocks 440. In some approaches, since the block 436 may move in two-dimensional (2D) space, X may represent a horizontal direction and Y may represent a vertical direction.

The motion vector variances may be combined to determine the neighbor activity measure. The neighbor activity measure may provide an indication of the confidence or reliability of the motion vector of the block 436. In some configurations, the neighbor activity measure may be determined in accordance with Equation (1). The neighbor activity measure may be utilized to determine the confidence measure corresponding to the motion vector of the block 436, for example.

FIG. 5 is a flow diagram illustrating an example of a method 500 for determining a neighbor activity measure. In some configurations, the electronic device 102 described in connection with FIG. 1 may perform the method 500. The electronic device 102 may determine 502 a motion vector for a block. This may be accomplished as described in connection with one or more of FIGS. 1-2. For example, the electronic device 102 may compare a block of pixels from an image with blocks of pixels in a search space of another image to produce metrics (e.g., cross-correlation metrics and/or SAD metric, etc.). The block of pixels in the search space with a best metric (e.g., highest cross-correlation metric and/or lowest SAD metric, etc.) may correspond to the endpoint of the motion vector.

The electronic device 102 may obtain 504 neighboring motion vectors corresponding to neighboring blocks. For example, the electronic device 102 may access a group of neighboring motion vectors corresponding to a block. In some configurations, one or more steps 504, 506, 508 of the neighbor activity determination may lag the motion vector determination 502 for a block. Referring to FIG. 4, for example, there may be a lag of two block rows (e.g., 8×8 block rows). For instance, the neighbor activity measure may be determined (e.g., processed) for the block 436 when the motion vector for the bottom right neighboring block 438 is determined. Obtaining 504 the neighboring motion vectors may include accessing a horizontal buffer (in hardware, for example) of motion vectors for one or more previous rows.

The electronic device 102 may determine 506 at least one measure of motion vector variance based on the motion vector and at least one of the neighboring motion vectors. This may be accomplished as described in connection with one or more of FIGS. 1 and 3-4. For example, the electronic device 102 may compute motion vector variance in a first direction (e.g., Var_{MV}_{_{X}}) and motion vector variance in a second direction (e.g., Var_{MV}_{_{Y}}) based on the motion vector and at least one neighboring motion vector (e.g., all the neighboring motion vectors corresponding to a set of blocks).

The electronic device 102 may determine 508 a neighbor activity measure based on the at least one measure of motion vector variance. This may be accomplished as described in connection with FIG. 4. In some approaches, the electronic device 102 may combine multiple measures of motion vector variance. For example, the electronic device 102 may combine (e.g., add) motion vector variance in a first direction to motion vector variance in a second direction to determine 508 the neighbor activity measure. In some configurations, the neighbor activity measure may be determined (e.g., constrained) within a range. In some approaches, the electronic device 102 may determine 508 the neighbor activity measure in accordance with Equation (1).

FIG. 6 is a flow diagram illustrating an example of a method 600 for determining a clustering measure. For instance, the electronic device 102 described in connection with FIG. 1 may perform the method 600 described in connection with FIG. 6 to determine the clustering measure in some configurations.

The electronic device 102 may accumulate 602 a set of selected motion vectors and associated costs. When searching for a motion vector, for instance, the electronic device 102 may search based on a number of candidates (e.g., candidate motion vectors). A candidate may indicate an area for searching. For example, a candidate may be a guiding motion vector that indicates an area for searching. For instance, candidates may be guiding locations to search for a motion vector for a current block (e.g., 8×8 block).

Examples of candidates may include a global candidate, which may represent global motion of an image, a local candidate, which may be motion generated with respect to a current block (e.g., (0, 0) of a current 8×8 block), a top neighbor candidate, which is a neighboring motion vector above the current block, a left neighbor candidate, which is a neighboring motion vector to the left of the current block, a bottom neighbor candidate, which is a neighboring motion vector below the current block, and/or a right neighbor candidate, which is a neighboring motion vector to the right of the current block, etc. One or more of the candidates may be used as a guide location and/or may be calculated before the current block. It should be noted that some optical flow algorithms may function with a pyramidal multi-flow approach to generate global and/or local candidates, which may be utilized to find the final motion vector. In some approaches for the clustering measure (e.g., K-means clustering measure), a number (e.g., K) of the best motion vectors may be accumulated from all candidates.

Searching each area may produce a number of motion vectors. Each of the motion vectors may have an associated cost. In some configurations, the associated cost may be a disparity (e.g., distance, difference, etc.) between a current pixel and a reference pixel. For example, motion may be predicted between frame n and another frame (e.g., frame n−1 or frame n+1, etc.). The current pixel may be a pixel from frame n, and the reference pixel may be a pixel from the other frame (e.g., frame n−1 or frame n+1, etc.). For example, the reference frame may depend on the direction of motion sought.

For each of the candidates, the electronic device 102 may select a number of motion vectors. For example, the electronic device 102 may determine selected motion vectors from the motion vectors associated with each candidate. For instance, the electronic device 102 may select a number of motion vectors with lowest associated costs from the motion vectors. The selected motion vectors may be utilized to perform clustering. In some approaches, the number of candidates may be denoted “M” and the number of selected motion vectors per candidate may be denoted “N.” Accordingly, the electronic device 102 may accumulate M*N selected motion vectors for clustering in some approaches. In some examples, M=6 and N=8, though it should be noted that other values may be utilized. In some approaches, the electronic device 102 may store the best M motions vectors for each N candidate and associated costs (from the motion vector or optical flow prediction pass, for instance). The motion vectors and costs may be utilized to determine the clustering measure.

The electronic device 102 may initialize 604 centroids and clusters. For example, the electronic device 102 may determine initial centroids and assign motion vectors to initial clusters. For instance, the location of a first centroid may be initially determined as the selected motion vector with the least cost, the location of a second centroid may be initially determined as the selected motion vector with an average of the least cost and highest cost, and the location of a third centroid may be determined as the selected motion vector with the highest cost. The electronic device 102 may perform cluster mapping and may change the centroids (e.g., re-compute centroids) for a number of iterations (e.g., 3). In some configurations, the electronic device 102 may initialize a variable to a value (e.g., set k=0). For example, one or more steps of the method 600 may be performed for a number of iterations after an initial iteration (e.g., for(k=1; k≤3; k++), where k is an iteration index). As can be observed, three centroids and/or clusters may be utilized in some configurations. Other numbers of centroids and/or clusters may be utilized in other configurations.

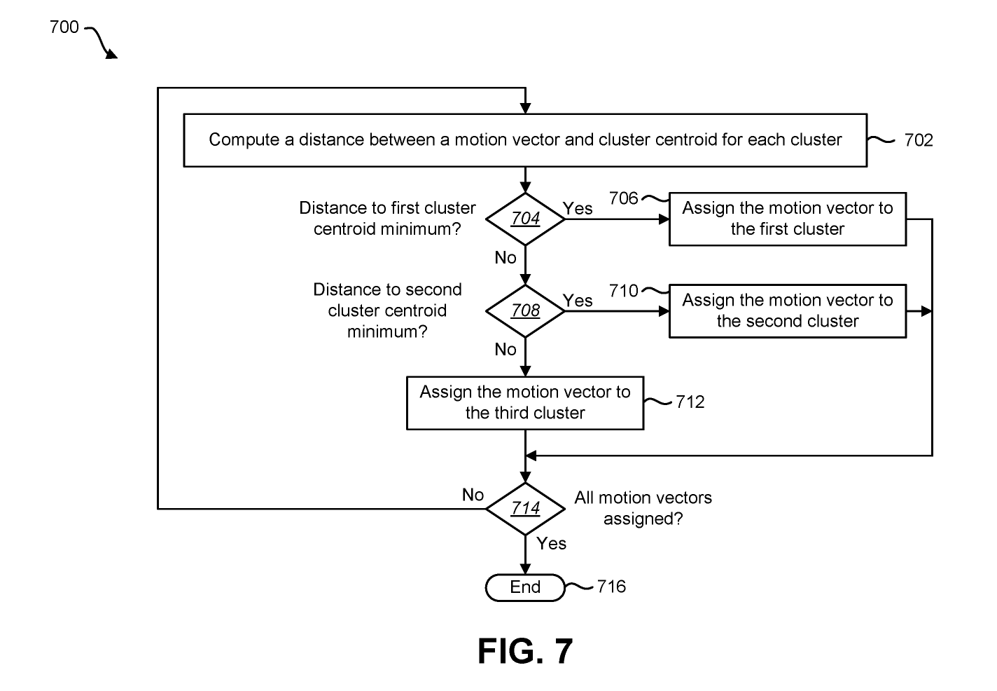

The electronic device 102 may map 606 each of the set of selected motion vectors to a cluster based on the centroids. In some approaches, the electronic device 102 may determine a distance between each selected motion vector and each centroid. Each of the selected motion vectors may be mapped to a cluster associated with the nearest centroid. For instance, for an index from 1 to M*N, the electronic device 102 may assign each motion vector to a cluster based on a shortest proximity to the cluster's centroid using a nearest neighbor approach. An example of mapping 606 motion vectors to clusters is given in connection with FIG. 7.

The electronic device 102 may re-compute 608 the centroids after the initial iteration. For example, the electronic device 102 may not re-compute the centroids for the initial iteration of the cluster mapping, but may re-compute 608 the centroids for one or more iterations after the initial iteration (e.g., if k>0). In some configurations, the electronic device 102 may re-compute 608 the centroids by averaging the motion vectors in each cluster. For example, a re-computed centroid may be an average (e.g., mean or median) of the motion vectors assigned to the cluster. In some approaches, a centroid is a mean of motion vectors in a cluster. Initial centroids may be selected from best, worst, and median cost location (e.g., may not be computed as a mean) in some approaches. In one or more subsequent iterations, the new centroids may be computed by averaging all motion vectors in each cluster.

The electronic device 102 may determine 610 whether to stop clustering. For example, the electronic device 102 may determine whether a condition is met to stop clustering. Examples of conditions may include a maximum number of iterations and/or whether the centroids are updated (e.g., whether a centroid has changed). In some configurations, the electronic device 102 may stop clustering if the centroids are not updated and it is not the initial iteration (e.g., centroids not updated && k>0). For example, if re-computing 608 the centroids has not changed the centroids after the initial iteration, clustering may stop. Additionally or alternatively, the electronic device 102 may stop clustering if a maximum number of iterations has been reached (e.g., k≥3). For example, clustering may stop if the following condition is met: [(centroids not updated && k>0)∥k≥3].

If the electronic device 102 determines 610 to not stop clustering (e.g., if the centroids have changed), the electronic device 102 may return to map 606 each of the selected motion vectors based on the updated centroids. In some configurations, the electronic device 102 may increment 612 a variable (e.g., k=k+1) to track the number of iterations. In some approaches, the clusters' motion vector distribution and cluster assignment for a best candidate may be maintained (e.g., stored in memory).

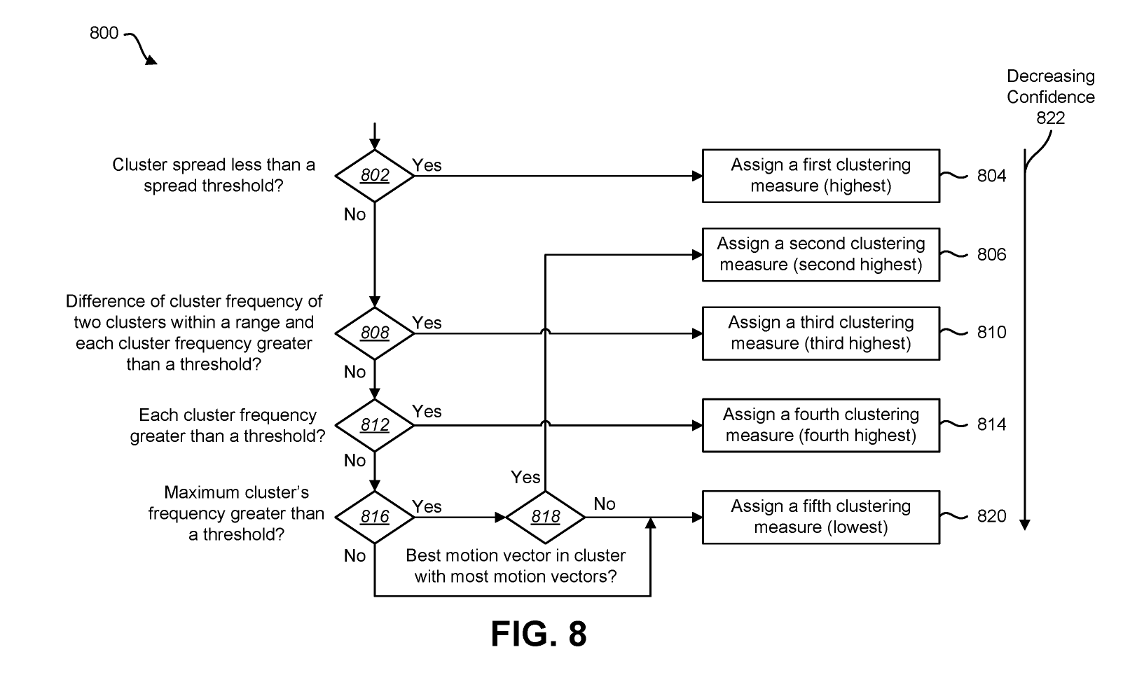

If the electronic device 102 determines 610 to stop clustering, the electronic device 102 may determine 614 a clustering measure based on the clusters. In some approaches, the electronic device 102 may determine the clustering measure based on one or more characteristics of the clusters. For instance, the electronic device 102 may determine the clustering measure based on how closely the clusters are spread (e.g., distance between cluster centroids), cluster frequency, and/or whether a best selected motion vector (e.g., a selected motion vector with the lowest cost) in included in a particular cluster. One or more characteristics may map to a cluster measure. In some approaches, a cluster measure may be determined from a set of cluster measures, where the cluster measures vary by degree of confidence. An example of determining 614 a clustering measure is given in connection with FIG. 8.

FIG. 7 is a flow diagram illustrating an example of a method 700 for mapping motion vectors to clusters. The method 700 may be performed by the electronic device 102 described in connection with FIG. 1. In some configurations, the method 700 may be performed for all of the selected motion vectors (e.g., for(i=0; i<M*N; i++), where i is a motion vector index).

The electronic device 102 may compute 702 a distance between a motion vector (e.g., one of the selected motion vectors) and a cluster centroid for each cluster. In some approaches, the electronic device 102 may determine the distances in accordance with Listing (1).

Listing (1)

Dist[i,K1] = ||MV(i) − K1_Centroid||₂
Dist[i,K2] = ||MV(i) − K2_Centroid||₂
Dist[i,K3] = ||MV(i) − K3_Centroid||₂

In Listing (1), Dist[ ] denotes a distance, i is the motion vector index, K1 denotes a first cluster, K2 denotes a second cluster, K3 denotes a third cluster, MV(i) denotes the i-th motion vector (from the set of selected motion vectors, for example), K1_Centroid denotes the centroid of the first cluster, K2_Centroid denotes the centroid of the second cluster, K3_Centroid denotes the centroid of the third cluster, and ∥ ∥₂ denotes the Euclidean norm.

The electronic device 102 may determine 704 whether a distance to the first cluster centroid (e.g., Dist[i,K1]) is the minimum distance. For example, the electronic device 102 may determine whether the distance between the motion vector and the centroid of the first cluster is the smallest of the distances to the centroids. In a case that the distance to the first cluster centroid is the minimum, the electronic device 102 may assign 706 the motion vector to the first cluster (e.g., assign MV(i) to K1).

In a case that the distance to the first cluster centroid is not the minimum, the electronic device 102 may determine 708 whether a distance to the second cluster centroid (e.g., Dist[i,K2]) is the minimum distance. For example, the electronic device 102 may determine whether the distance between the motion vector and the centroid of the second cluster is the smallest of the distances to the centroids. In a case that the distance to the second cluster centroid is the minimum, the electronic device 102 may assign 710 the motion vector to the second cluster (e.g., assign MV(i) to K2). In a case that the distance to the second cluster centroid is not the minimum, the electronic device 102 may assign 712 the motion vector to the third cluster (e.g., assign MV(i) to K3).

The electronic device 102 may determine 714 whether all of the motion vectors (e.g., all of the motion vectors in the set of selected motion vectors) are assigned. In a case that all motion vectors are not assigned, the electronic device 102 may repeat one or more steps of the method 700 for a next motion vector. In a case that all motion vectors are assigned, operation may end 716. For example, cluster assignment may end for the current iteration (e.g., for the current k). It should be noted that the method 700 may be repeated for one or more subsequent iterations based on re-computed centroids. It should also be noted that although the example described in connection with FIG. 7 includes three clusters, a different number of clusters may be implemented in other examples.

FIG. 8 is a flow diagram illustrating an example of a method 800 for determining a clustering measure based on clusters. As illustrated in FIG. 8, the method 800 may assign varying cluster measures based on one or more cluster characteristics. An example of an order of decreasing confidence 822 is illustrated in FIG. 8. The method 800 may be performed by the electronic device 102 described in connection with FIG. 1. In some configurations, a lower valued clustering measure may indicate higher confidence.

The electronic device 102 may determine 802 whether a cluster spread is less than a threshold. For example, the electronic device 102 may determine whether the cluster centroids are within a threshold distance from each other. In some approaches, the threshold distance may be a heuristic value. For example, the threshold distance may be 1 or 2. If the cluster spread is less than the threshold, the electronic device 102 may assign 804 a first clustering measure (e.g., a clustering measure with highest confidence).

If the cluster spread is not within the threshold (e.g., if the cluster spread is greater than or equal to the threshold), the electronic device 102 may determine 808 whether a difference of the cluster frequency of two clusters is within a range and each cluster frequency is greater than a first frequency threshold. As described herein, a cluster frequency may be a number of motion vectors within the cluster or a proportion (e.g., percentage) of motion vectors within the cluster. The range may be expressed as a number or a proportion (e.g., percentage). For example, the range may be a percentage of M*N. The range may be heuristically tuned in some approaches. The first frequency threshold may be expressed as a number or a proportion (e.g., percentage). If the difference of the cluster frequency of two clusters is within the range and each cluster frequency is greater than the first frequency threshold, the electronic device 102 may assign 810 a third clustering measure (e.g., a clustering measure with third highest confidence).

In some configurations, the determination 808 may include determining a difference (e.g., absolute value of the difference) between one or more pairs of cluster frequencies (e.g., K0−K1, K0−K2, and K2−K1) and determining whether each difference satisfies (e.g., is less than or equal to) a threshold. The determination 808 may also include determining a sum of one or more pairs of cluster frequencies (e.g., K0+K1, K0+K2, and K2+K1) and determining whether each sum satisfies (e.g., is greater than or equal to) a threshold. For instance, if the absolute difference between a pair of cluster frequencies is less than or equal to a threshold and the sum of the pair of cluster frequencies is greater than or equal to a threshold, then the third clustering measure may be assigned 810.

One example of the determination 808 is given as follows. In this example, K0, K1, and K2 denote cluster frequencies for a first cluster, a second cluster, and a third cluster, respectively, where K0=20, K1=21, and K2=7. It may be observed that the total=K0+K1+K2=20+21+7=48=M*N=6*8, for instance. The range (e.g., proximity range) is 2 and the first frequency threshold (e.g., combined cluster frequency threshold) is 40. The determination 808 may be computed in accordance with the following expression: ABS(K0−K1)≤2 && (K0+K1)≥40. In this case, the first and second clusters may be determined to be approximately equally likely. The third clustering measure may be assigned 810.

Another example of the determination 808 is given in terms of percentage as follows. In this example, K0, K1, and K2 denote cluster frequencies for a first cluster, a second cluster, and a third cluster, respectively, where K0=40%, K1=42%, and K2=18%. The range (e.g., proximity range or “UNIFORM_BIN_TH_2” in Listing (2) below) is 2% and the first frequency threshold (e.g., combined cluster frequency threshold or “TH1” in Listing (2) below) is 80%. The determination 808 may be computed in accordance with the following expression: ABS(K0−K1)≤2% && (K0+K1)≥80%. The first and second clusters with K0 and K1 may be grouped together because they are within 2% of each other. As can be observed, the two cluster frequencies combine to be greater than 80% (i.e., 40%+42% ≥80%). In this case, the first and second clusters may be determined to be approximately equally likely. The third clustering measure may be assigned 810.

If the difference of the cluster frequency of two clusters is not within the range or each cluster frequency is not greater than the first frequency threshold, the electronic device 102 may determine 812 whether each cluster frequency is greater than a second frequency threshold (e.g., “TH2” in Listing (2) below). The second frequency threshold may be different from the first frequency threshold for grouping. The second frequency threshold may be expressed as a number or percentage. In one example, the second frequency threshold may be 30%. For instance, if each cluster frequency of three clusters is greater than 30%, then the three clusters may be approximately equally likely. If each cluster frequency is greater than the second frequency threshold, the electronic device 102 may assign 814 a fourth clustering measure (e.g., a clustering measure with fourth highest confidence).

If each cluster frequency is not greater than the second frequency threshold, the electronic device 102 may determine 816 whether a maximum cluster's frequency is greater than a third frequency threshold (e.g., 80% or another value). The maximum cluster's frequency may be the maximum cluster frequency of all of the clusters. If the maximum cluster's frequency is not greater than the third frequency threshold, the electronic device 102 may assign 820 a fifth clustering measure (e.g., a clustering measure with lowest confidence).

If the maximum cluster's frequency is greater than the third frequency threshold, the electronic device 102 may determine 818 whether a best motion vector (e.g., a selected motion vector with the lowest cost) is included in the cluster with the most motion vectors. If the best motion vector is not included in the cluster with the most motion vectors, the electronic device 102 may assign 820 a fifth clustering measure (e.g., a clustering measure with lowest confidence). If the best motion vector is included in the cluster with the most motion vectors, the electronic device 102 may assign 806 a second clustering measure (e.g., a clustering measure with second highest confidence).

In some configurations, determining the clustering measure (e.g., the method 800) may be performed in accordance with Listing (2).

Listing (2)

If (Clusters centroid spread < CLUSTER_PROXIMITY)
Set Confidence = KMEANS_CONFIDENCE_C0 //Energy is closely spread
Else If //Two likely

((ABS( K0 − K1) <= UNIFORM_BIN_TH_2) && ((K0 + K1) >= TH1)) ||
((ABS( K0 − K2) <= UNIFORM_BIN_TH_2) && ((K0 + K2) >= TH1)) ||
((ABS( K2 − K1) <= UNIFORM_BIN_TH_2) && ((K2 + K1) >= TH1))

Set Confidence = KMEANS_CONFIDENCE_C2

Else If //Three likely

((K0 > TH2) &&
(K1 > TH2) &&
(K2 > TH2))

Set Confidence = KMEANS_CONFIDENCE_C3

Else If (Freq[BestClusterK] > BestClusterFreq_TH)) //Single Max cluster

{

If (Max_Freq_Cluster != BestCandidateCluster)

Set Confidence = KMEANS_CONFIDENCE_C4

Else

Set Confidence = KMEANS_CONFIDENCE_C1

}

Else

Set Confidence = KMEANS_CONFIDENCE_C4

In Listing (2), Set Confidence may denote a determined clustering measure, where KMEANS_CONFIDENCE_C0, KMEANS_CONFIDENCE_C1, KMEANS_CONFIDENCE_C2, KMEANS_CONFIDENCE_C3, and KMEANS_CONFIDENCE_C4 are varying examples of the clustering measure. CLUSTER_PROXIMITY is an example of the threshold for cluster spread. In Listing (2), K0 is a first cluster frequency, K1 is a second cluster frequency, K2 is a third cluster frequency, ABS denotes absolute value, BestClusterK is a cluster that includes a motion vector with least cost (e.g., best motion vector of M*N), Freq[BestClusterK] is a function that returns the cluster frequency of BestClusterK, BestClusterFreq_TH is the cluster frequency of the (e.g., singly) most populous cluster (e.g., 50% of M*N), Max_Freq_Cluster indicates which cluster is the maximum frequency cluster (i.e., among K0, K1, and K2 that has the highest distribution), and BestCandidateCluster=BestClusterK. The ABS( ) function may provide an absolute difference between cluster frequencies (without a negative sign) when taking the difference between cluster frequencies.

In some configurations, the clustering measure may range from 0 to 15. Examples of values for the clustering measure are given in Table (1).

TABLE (1)

| Confidence | Value |
|---|---|
| Highest (e.g., KMEANS_CONFIDENCE_C0) | 0 |
| Second Highest (e.g., KMEANS_CONFIDENCE_C1) | 4 |
| Third Highest (e.g., KMEANS_CONFIDENCE_C2) | 8 |
| Fourth Highest (e.g., KMEANS_CONFIDENCE_C3) | 12 |
| Lowest (e.g., KMEANS_CONFIDENCE_C4) | 15 |

It should be noted that different values may be used for the confidence measure and/or different numbers of potential values may be used.

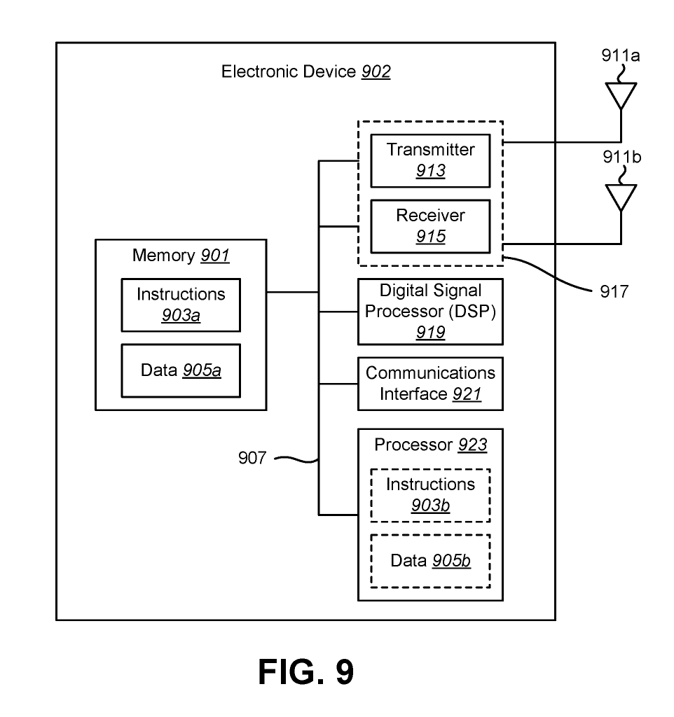

FIG. 9 illustrates certain components that may be included within an electronic device 902 configured to implement various configurations of the systems and methods disclosed herein. The electronic device 902 may be an access terminal, a mobile station, a user equipment (UE), a smartphone, a digital camera, a video camera, a tablet device, a laptop computer, etc. The electronic device 902 may be implemented in accordance with one or more of the electronic devices 102 described herein. The electronic device 902 includes a processor 923. The processor 923 may be a general purpose single- or multi-chip microprocessor (e.g., an ARM), a special purpose microprocessor (e.g., a digital signal processor (DSP)), a microcontroller, a programmable gate array, etc. The processor 923 may be referred to as a central processing unit (CPU). Although just a single processor 923 is shown in the electronic device 902, in an alternative configuration, a combination of processors (e.g., an ARM and DSP) could be implemented.

The electronic device 902 also includes memory 901. The memory 901 may be any electronic component capable of storing electronic information. The memory 901 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 905a and instructions 903a may be stored in the memory 901. The instructions 903a may be executable by the processor 923 to implement one or more of the methods 200, 300, 500, 600, 700, 800 described herein. Executing the instructions 903a may involve the use of the data 905a that is stored in the memory 901. When the processor 923 executes the instructions 903, various portions of the instructions 903b may be loaded onto the processor 923, and/or various pieces of data 905b may be loaded onto the processor 923.

The electronic device 902 may also include a transmitter 913 and a receiver 915 to allow transmission and reception of signals to and from the electronic device 902. The transmitter 913 and receiver 915 may be collectively referred to as a transceiver 917. One or more antennas 911a-b may be electrically coupled to the transceiver 917. The electronic device 902 may also include (not shown) multiple transmitters, multiple receivers, multiple transceivers and/or additional antennas.

The electronic device 902 may include a digital signal processor (DSP) 919. The electronic device 902 may also include a communications interface 921. The communications interface 921 may allow and/or enable one or more kinds of input and/or output. For example, the communications interface 921 may include one or more ports and/or communication devices for linking other devices to the electronic device 902. In some configurations, the communications interface 921 may include the transmitter 913, the receiver 915, or both (e.g., the transceiver 917). Additionally or alternatively, the communications interface 921 may include one or more other interfaces (e.g., touchscreen, keypad, keyboard, microphone, camera, etc.). For example, the communication interface 921 may enable a user to interact with the electronic device 902.

The various components of the electronic device 902 may be coupled together by one or more buses, which may include a power bus, a control signal bus, a status signal bus, a data bus, etc. For the sake of clarity, the various buses are illustrated in FIG. 9 as a bus system 907.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed, or computed by the computing device or processor. As used herein, the term “code” may refer to software, instructions, code, or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B, and C” or the phrase “one or more of A, B, or C” should be interpreted to mean any of: only A, only B, only C, A and B (but not C), B and C (but not A), A and C (but not B), or all of A, B, and C.

It is to be understood that the claims are not limited to the precise configurations and components illustrated above. Various modifications, changes, and variations may be made in the arrangement, operation, and details of the systems, methods, and apparatus described herein without departing from the scope of the claims.

What is claimed is:

1. A method performed by an electronic device, comprising:
determining, in a loop, a plurality of motion vectors for an image; and
determining a confidence measure for at least one of the plurality of motion vectors in the loop with the motion vector determination.

2. The method of claim 1, wherein the confidence measure is determined without global image statistics.

3. The method of claim 1, wherein determining the confidence measure comprises determining a neighbor activity measure for the at least one of the motion vectors.

4. The method of claim 3, wherein determining the neighbor activity measure comprises determining at least one measure of motion vector variance based on the at least one of the motion vectors and at least one neighboring motion vector.

5. The method of claim 1, wherein determining the confidence measure comprises determining a clustering measure for the at least one of the motion vectors.

6. The method of claim 5, wherein determining the clustering measure comprises determining a distribution of one or more K-means clusters of candidate motion vectors.

7. The method of claim 5, wherein determining the confidence measure is based on a combination of a neighbor activity measure and the clustering measure.

8. The method of claim 1, wherein the confidence measure is a numeric value of a non-binary range.

9. The method of claim 1, further comprising outputting a motion vector field with associated confidence measures corresponding to the image.

10. The method of claim 1, further comprising tracking an object in the image based on the confidence measure.

11. The method of claim 1, further comprising registering the image based on the confidence measure.

12. An electronic device, comprising:
a processor configured to:
determine, in a loop, a plurality of motion vectors for an image; and
determine a confidence measure for at least one of the motion vectors in-loop with the motion vector determination.

13. The electronic device of claim 12, wherein the confidence measure is determined without global image statistics.

14. The electronic device of claim 12, wherein the processor is configured to determine the confidence measure by determining a neighbor activity measure for the at least one of the motion vectors.

15. The electronic device of claim 14, wherein the processor is configured to determine the neighbor activity measure by determining at least one measure of motion vector variance based on the at least one of the motion vectors and at least one neighboring motion vector.

16. The electronic device of claim 12, wherein the processor is configured to determine the confidence measure by determining a clustering measure for the at least one of the motion vectors.

17. The electronic device of claim 16, wherein the processor is configured to determine the clustering measure by determining a distribution of one or more K-means clusters of candidate motion vectors.

18. The electronic device of claim 16, wherein determining the confidence measure is based on a combination of a neighbor activity measure and the clustering measure.

19. The electronic device of claim 12, wherein the confidence measure is a numeric value of a non-binary range.

20. The electronic device of claim 12, wherein the processor is configured to output a motion vector field with associated confidence measures corresponding to the image.

21. The electronic device of claim 12, wherein the processor is configured to track an object in the image based on the confidence measure.

22. The electronic device of claim 12, wherein the processor is configured to register the image based on the confidence measure.

23. An apparatus, comprising:
means for determining, in a loop, a plurality of motion vectors for an image; and
means for determining a confidence measure for at least one of the motion vectors in-loop with the motion vector determination.

24. The apparatus of claim 23, wherein the confidence measure is determined without global image statistics.

25. The apparatus of claim 23, wherein the means for determining the confidence measure comprises means for determining a neighbor activity measure for the at least one of the motion vectors.

26. The apparatus of claim 23, wherein means for determining the confidence measure comprises means for determining a clustering measure for the at least one of the motion vectors.

27. A non-transitory tangible computer-readable medium storing computer executable code, comprising:
code for causing an electronic device to determine, in a loop, a plurality of motion vectors for an image; and
code for causing the electronic device to determine a confidence measure for a motion vector in-loop with the motion vector determination.

28. The computer-readable medium of claim 27, wherein the confidence measure is determined without global image statistics.

29. The computer-readable medium of claim 27, wherein the code for causing the electronic device to determine the confidence measure comprises code for causing the electronic device to determine a neighbor activity measure for the at least one of the motion vectors.

30. The computer-readable medium of claim 27, wherein the code for causing the electronic device to determine the confidence measure comprises code for causing the electronic device to determine a clustering measure for the at least one of the motion vectors.
